(19) United States
(12) Patent Application Publication
(10) Pub. No.: US 2026/0169292 A1
(43) Pub. Date: Jun. 18, 2026

(54) AR GLASSES FOR PROVIDING CLEAR VIEW OF REAL WORLD IN FOVEA REGION

(71) Applicant: Korea Electronics Technology Institute, Seongnam-si (KR)

(72) Inventors: Ji Soo HONG, Seoul (KR); Sung Hee HONG, Seoul (KR); Young Min KIM, Seoul (KR); Jin Soo JEONG, Seoul (KR); Yong Hwa KIM, Seoul (KR); Byoung Hyo LEE, Seoul (KR); Hyeon Chan OH, Seoul (KR)

(73) Assignee: Korea Electronics Technology Institute, Seongnam-si (KR)

(21) Appl. No.: 19/002,129

(22) Filed: Dec. 26, 2024

(30) Foreign Application Priority Data
Dec. 16, 2024 (KR) 10-2024-0187308

(51) Int. Cl. G02B 27/01; G02B 27/00

(52) U.S. Cl. CPC G02B 27/0172; G02B 27/0012; G02B 27/0081; G02B 2027/0134; G02B 2027/0178

(57) ABSTRACT

Provided are AR glasses which provide a clearer view of the real world of the fovea region. The AR glasses according to an embodiment may provide a virtual image only through the peripheral vision region while the fovea region is open. Accordingly, a clearer view of the real world of the fovea region may be provided, and in particular, in an environment with poor visibility, visual strain and discomfort that a user may have due to the AR glasses may be solved.

### CROSS-REFERENCE TO RELATED APPLICATION(S) AND CLAIM OF PRIORITY

This application is based on and claims priority under 35 U.S.C. § 119 to Korean Patent Application No. 10-2024-0187308, filed on Dec. 16, 2024, in the Korean Intellectual Property Office, the disclosure of which is herein incorporated by reference in its entirety.

### BACKGROUND

### Field

The disclosure relates to augmented reality (AR) glasses, and more particularly, to AR glasses for maximizing clarity of the real world in the fovea region.

### Description of Related Art

Related-art AR glasses may use a glass module (eyeglasses in AR glasses) with optical members performing the roles of an in-coupler 20, a redirector 30, an out-coupler 40 attached on a transparent substrate 10, as shown in FIG. 1, in order to make a thin glass module that can show virtual images provided by a small projection system by superimposing over the real world. The in-coupler 20, the redirector 30, and the out-coupler 40 may be implemented by using such a structure as a surface relief grating, a volume grating, and a stacked half-mirror.

Accordingly, when a virtual image projected from a projection module 50 enters the in-coupler 20, the virtual image is transmitted to user's pupil positioned at the out-coupler 30 as shown in FIG. 2. Since the transparent 10, the in-coupler 20, the redirector 30, and the out-coupler 40 are nearly transparent, the user may see the virtual image superimposed over the real world through the AR glasses.

However, since the transparent substrate 10 and the out-coupler 40 are not completely transparent, the related-art AR glasses may have the limit to providing a clear view of the real world to a user (for example, a diver) in an environment (for example, underwater) with poor visibility, and accordingly, the user may have visual strain and discomfort due to the presence of AR glasses.

### SUMMARY

The disclosure has been developed in order to solve the above-described problems, and an object of the disclosure is to provide, as a solution for providing a clearer view of the real world of the fovea region in AR glasses, an AR glass module which provides a virtual image only through a peripheral vision region while the fovea region is open, and AR glasses using the same.

To achieve the above-described object, a glass module for AR glasses according to an embodiment of the disclosure may include: a transparent substrate; an in-coupler attached to the transparent substrate to allow a virtual image to enter therethrough; a light transmitter attached to the transparent substrate to transmit the virtual image entering through the in-coupler to an out-coupler; and an out-coupler attached to the transparent substrate to emit the virtual image transmitted through the light transmitter to user's pupil, and the out-coupler may be attached to an edge region of the transparent substrate.

The transparent substrate may have a center region that is opened. The transparent substrate may have an inner side region that is also opened.

The center region and the inner side region of the transparent substrate may correspond to a fovea region of the user, and the edge region of the transparent substrate may correspond to a peripheral vision region of the user.

The in-coupler and the light transmitter may be attached to the edge region of the transparent substrate.

The in-coupler may include: an upper in-coupler configured to receive a part of the virtual image and to split the part of the virtual image upwardly; and a lower in-coupler configured to receive a part of the virtual image and to split the part of the virtual image downwardly, the light transmitter may include: an upper light transmitter configured to transmit the virtual image which is split upwardly by the in-coupler to an upper out-coupler; and a lower light transmitter configured to transmit the virtual image which is split downwardly by the lower in-coupler to a lower out-coupler, and the out-coupler may include the upper out-coupler configured to emit the virtual image transmitted through the upper light transmitter; and the lower out-coupler configured to emit the virtual image transmitted through the lower light transmitter.

The upper out-coupler may be attached to an upper region of the transparent substrate, and the lower out-coupler may be attached to a lower region of the transparent substrate. The upper in-coupler, the lower in-coupler, the upper light transmitter, and the lower light transmitter may be attached to outer side regions of the transparent substrate.

The upper out-coupler and the lower out-coupler may emit the virtual image to a plurality of out-coupler elements at a plurality of points.

According to another embodiment of the disclosure, an AR virtual image display method may include: receiving, by an in-coupler attached to a transparent substrate, a virtual image; transmitting, by a light transmitter attached to the transparent substrate, the virtual image entering through the in-coupler to an out-coupler; and emitting, by an out-coupler attached to the transparent substrate, the virtual image transmitted through the light transmitter to user's pupil, and the out-coupler may be attached to an edge region of the transparent substrate.

According to still another embodiment of the disclosure, AR glasses may include: a left-eye glass module configured to display a left-eye virtual image on user's left eye; a right-eye glass module configured to display a right-eye virtual image on user's right eye; a left-eye projection module configured to project the left-eye virtual image to be displayed through the left-eye glass module; and a right-eye projection module configured to project the right-eye virtual image to be displayed through the right-eye glass module, each of the left-eye glass module and the right-eye glass module may include: a transparent substrate; an in-coupler attached to the transparent substrate to allow a virtual image to enter therethrough; a light transmitter attached to the transparent substrate to transmit the virtual image entering through the in-coupler to an out-coupler; and an out-coupler attached to the transparent substrate to emit the virtual image transmitted through the light transmitter to user's pupil, and the out-coupler may be attached to an edge region of the transparent substrate.

According to embodiments of the disclosure as described above, the AR glasses may provide a virtual image only through the peripheral vision region while the fovea region is open, so that a clearer view of the real world of the fovea region may be provided. In particular, in an environment with poor visibility, visual strain and discomfort that a user may have due to the AR glasses may be solved.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating a glass module structure for related-art AR glasses;

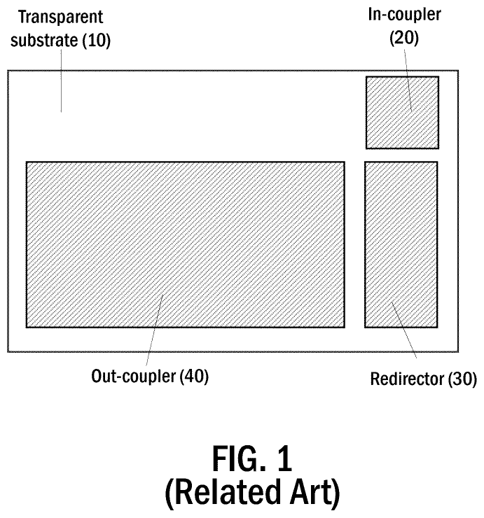

FIG. 2 is a view illustrating an overall structure of related-art AR glasses;

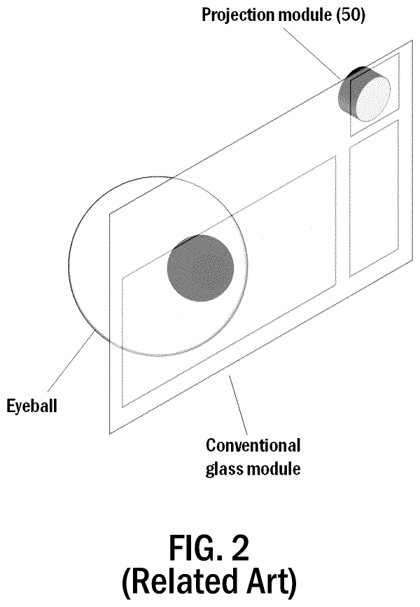

FIG. 3 is a view illustrating a virtual image display method to which embodiments of the disclosure are applicable;

FIG. 4 is a view illustrating a structure of a glass module for AR glasses according to an embodiment of the disclosure;

FIG. 5 is a view illustrating a left-eye glass module applied to AR glasses;

FIG. 6 is a view illustrating functions of an in-coupler;

FIG. 7 is a view illustrating functions of the in-coupler;

FIG. 8 is a view illustrating functions of an out-coupler;

FIG. 9 is a view illustrating functions of an out-coupler;

FIG. 10 is a view illustrating a detailed structure of an upper out-coupler;

FIG. 11 is a view illustrating the detailed structure of the upper out-coupler;

FIG. 12 is a view illustrating optical paths in the glass module; and

FIG. 13 is a view illustrating a configuration of AR glasses according to another embodiment of the disclosure.

### DETAILED DESCRIPTION

Hereinafter, the disclosure will be described in more detail with reference to the accompanying drawings.

Embodiments of the disclosure propose an AR glass module which provides a clearer view of the real world of the fovea region, and AR glasses using the same. The disclosure relates to a technology that provides a virtual image only through a peripheral vision region while the fovea region is open in an AR glass module for AR glasses.

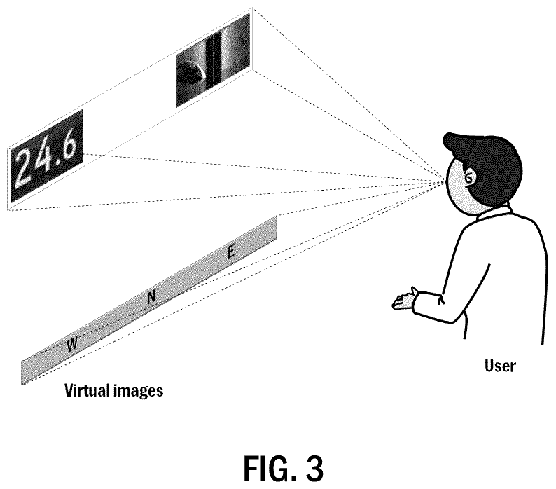

Embodiments of the disclosure may be implemented by a structure that displays virtual images only on an upper portion and a lower portion corresponding to peripheral vision regions, as shown in FIG. 3, and furthermore, has the fovea region opened without having any optical elements therein in the glass module, to provide a clear view of the real world of the fovea region to a user.

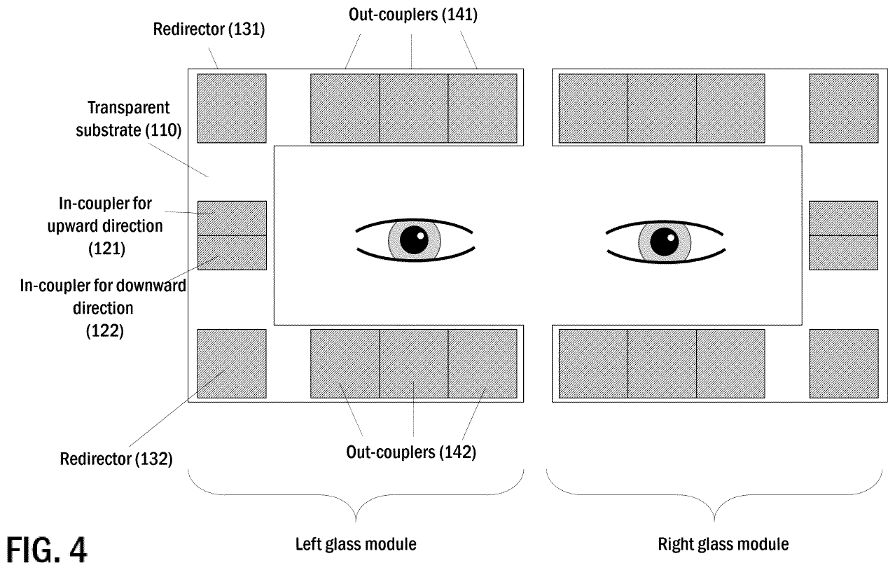

FIG. 4 illustrates a structure of a glass module for AR glasses according to an embodiment of the disclosure. The glass module illustrated is eyeglass parts positioned on the front surface of the AR glasses. As shown in FIG. 4, the glass module according to an embodiment of the disclosure may include a left-eye glass module and a right-eye glass module.

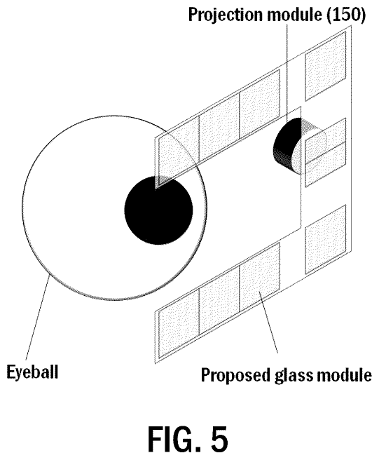

The left-eye glass module applied to the AR glasses is illustrated in FIG. 5. As shown in FIG. 5, the left-eye glass module displays virtual images projected and entering from a projection module 150 through an upper region and a lower region. The left-eye glass module and the right-eye glass module may have the same components arranged symmetrically, and thus only the components included in the right-eye glass module will be described hereinbelow.

As shown in FIG. 4, the right-eye glass module may include a transparent substrate 110, in-couplers 121, 122, redirectors 131, 132, out-couplers 141, 142.

The transparent substrate 110 is a component corresponding to the body of the glass module, and functions as a waveguide to guide virtual images. The transparent substrate 110 may have a center region and an inner side region corresponding to user's fovea region that are opened. Here, the center region and the inner side region may correspond to the fovea region, and have a predetermined size with reference to the position of user's pupil. The “inner side” of the inner side region is defined with reference to user's face, and the inner side region of the right-eye glass module is a left side region, and the inner side region of the left-eye glass module is a right side region.

The in-couplers 121, 122, the redirectors 131, 132, and the out-couplers 141, 142 may be attached to edge regions of the transparent substrate 110. Specifically, the in-couplers 121, 122 may be attached to outer side regions of the transparent substrate 110, the redirectors 131, 132 may be attached to outer corner regions of the transparent substrate 110, and the out-couplers 141, 142 may be attached to an upper portion and a lower portion of the transparent substrate 110, respectively. The edge regions of the transparent substrate 110 to which the in-couplers 121, 122, the redirectors 131, 132, and the out-couplers 141, 142 are attached may be peripheral vision regions, that is, outer regions of the fovea region.

The in-couplers 121, 122 are components that the virtual image projected from the projection module (not shown) of the AR glasses enters, and may include an upper in-coupler 121 and a lower in-coupler 122. A part of the virtual image may enter the upper in-coupler 121, and the other part of the virtual image may enter the lower in-coupler 122.

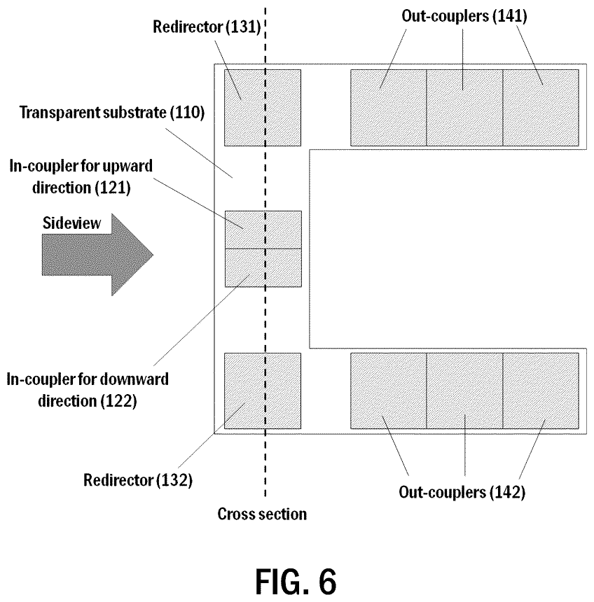

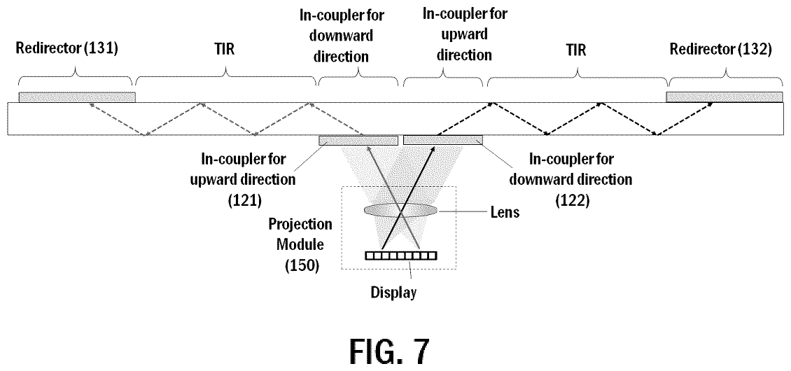

FIG. 7 illustrates a cross-sectional view taken by cutting the outer side region of the right-eye glass module along the dashed line as shown in FIG. 6 and viewed from side to explain functions of the in-couplers 121, 122. Directions in which the virtual images projected by the in-coupler 121, 122 travel are illustrated in FIG. 7.

As shown in FIG. 7, the bottom half of the virtual image entering the upper in-coupler 121 travels while performing total internal reflection (TIR) in the upward direction within the waveguide, and the top half of the virtual image entering the lower in-coupler 122 travels while performing TIR in the downward direction within the waveguide. The bottom half of the virtual image should represent a virtual image to be displayed on the upper portion of the glass module since it travels upwards, and the top half of the virtual image should represent a virtual image to be displayed on the lower portion of the glass module since it travels downwards.

Reference is made back to FIG. 4. The redirectors 131, 132 are light-transmission elements to transmit the virtual image entering through the in-couplers 121, 122 to the out-couplers 141, 142, and may include an upper redirector 131 and a lower redirector 132. The upper redirector 131 may bend the direction of the virtual image that enters the upper in-coupler 121 and is split upwardly by 90 degrees, and may transmit the virtual image to the upper out-coupler 131, and the lower redirector 132 may bend the direction of the virtual image that enters the lower in-coupler 122 and is split downwardly by 90 degrees, and may transmit the virtual image to the lower out-coupler 142.

The out-couplers 141, 142 are components to emit the virtual image transmitted through the redirectors 131, 132 to user's pupil, and may include an upper out-coupler 141 and a lower out-coupler 142. The upper out-coupler 141 may emit the virtual image transmitted through the upper redirector 131 to the upper portion of the glass module, and the lower out-coupler 142 may emit the virtual image transmitted through the lower redirector 132 to the lower portion of the glass module.

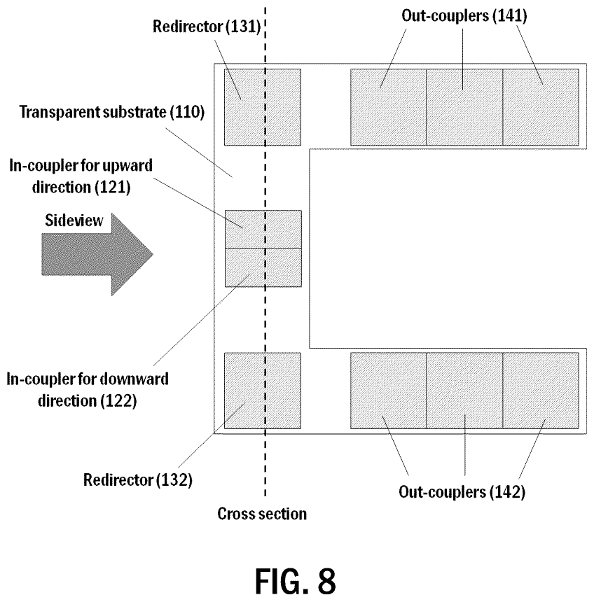

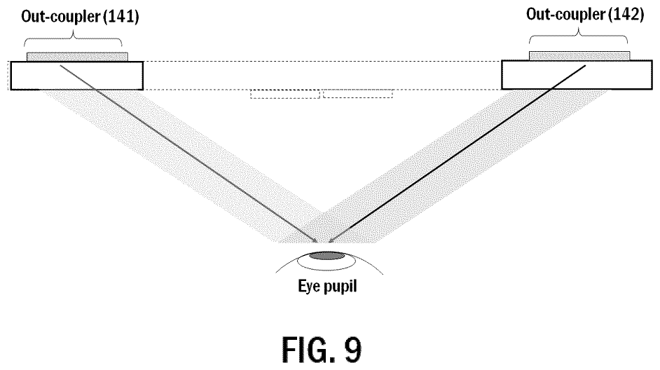

FIG. 9 illustrates a cross-sectional view taken by cutting the center of the right-eye glass module along the dashed line as shown in FIG. 8 and viewed from side to explain functions of the out-couplers 141, 142. The out-couplers 141, 142 change the traveling direction of the virtual image to face the user's pupil as shown in FIG. 9.

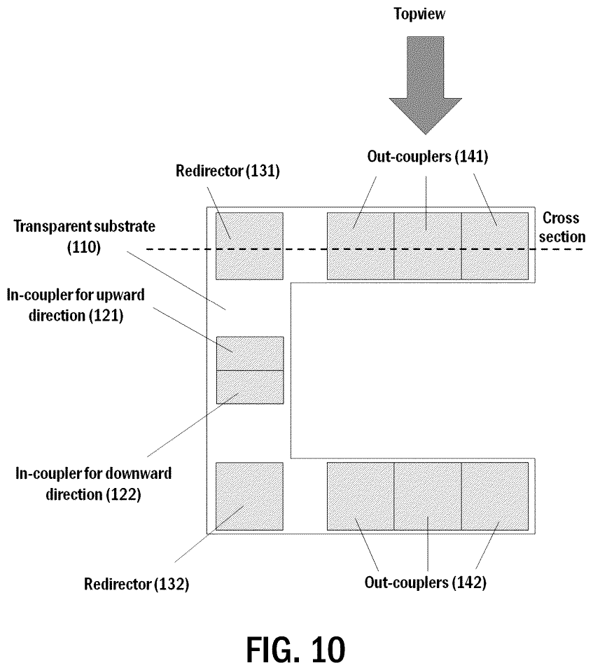

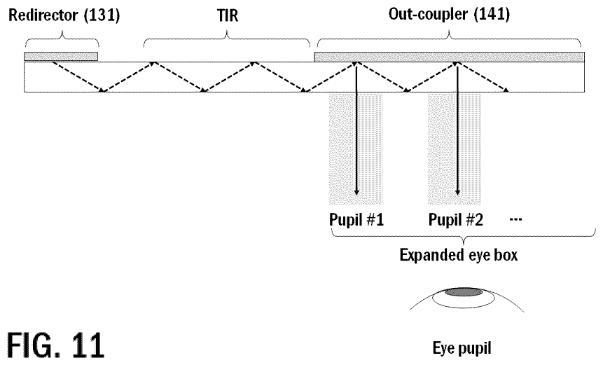

FIG. 11 illustrates a cross-sectional view taken by cutting the upper portion of the right-eye glass module along the dashed line as shown in FIG. 10 and viewed from top to explain a detailed structure of the upper out-coupler 141. As shown in FIG. 11, the upper out-coupler 141 may have a plurality of out-coupler elements having different coupling efficiencies to emit the virtual images guided through the waveguide in sequence, and to divide the amount of light of the virtual images and display on different eye boxes, thereby expanding the eye boxes. The detailed structure and the function described above are the same as those of the lower out-coupler 142.

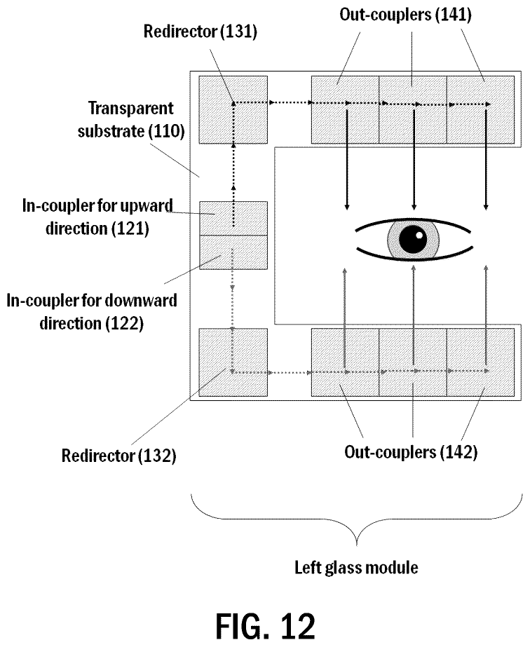

FIG. 12 illustrates optical paths as viewed from the front of the glass module according to an embodiment of the disclosure. As shown in FIG. 12, the virtual image entering through the in-couplers 121, 123 may be divided into an upper image and a lower image and may be guided within the waveguide, and the redirectors 131, 132 may bend the traveling direction of the guided virtual image toward the out-couplers 141, 142. The out-couplers 141, 142 may emit the arriving virtual images toward user's pupil through various out-coupler elements, thereby expanding eye boxes through pupil replication.

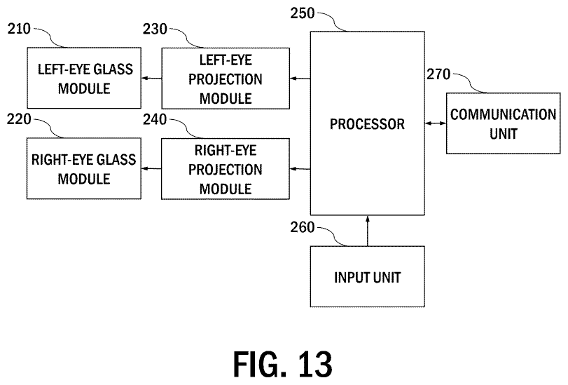

FIG. 13 is a view illustrating a configuration of AR glasses according to another embodiment of the disclosure. The AR glasses according to an embodiment of the disclosure may include a left-eye glass module 210, a right-eye glass module 220, a left-eye projection module 230, a right-eye projection module 240, a processor 250, an input unit 260, and a communication unit 270.

The left-eye glass module 210 and the right-eye glass module 220 are configured to display a left-eye virtual image and a right-eye virtual image on the user's left eye and right eye, respectively, and is implemented as proposed in FIG. 4 described above.

The left-eye projection module 230 may project a left-eye virtual region to be displayed through the left-eye glass module 210, and the right-eye projection module 240 may project a right-eye virtual region to be displayed through the right-eye glass module 220.

The processor 250 may generate a left-eye virtual image and a right-eye virtual image, and may transmit the same to the left-eye projection module 230 and the right-eye projection module 240, respectively. When generating the virtual images, the processor 250 may use information received from an external server or a user terminal through the communication unit 270, and may reflect a user command received through the input unit 260.

Up to now, AR glasses which can provide a clearer view of the real world of the fovea region has been described in detail with reference to preferred embodiments.

In the above-described embodiments, the AR glasses may provide a virtual image only through the peripheral vision region while the fovea region is open, so that a clearer view of the real world of the fovea region may be provided. In particular, in an environment with poor visibility, visual strain and discomfort that a user may have due to the AR glasses may be solved.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A glass module for AR glasses, the glass module comprising:
a transparent substrate;
an in-coupler attached to the transparent substrate to allow a virtual image to enter therethrough;
a light transmitter attached to the transparent substrate to transmit the virtual image entering through the in-coupler to an out-coupler; and
an out-coupler attached to the transparent substrate to emit the virtual image transmitted through the light transmitter to user's pupil,
wherein the out-coupler is attached to an edge region of the transparent substrate.

2. The glass module for the AR glasses of claim 1, wherein the transparent substrate has a center region that is opened.

3. The glass module for the AR glasses of claim 2, wherein the transparent substrate has an inner side region that is also opened.

4. The glass module for the AR glasses of claim 3, wherein the center region and the inner side region of the transparent substrate correspond to a fovea region of the user, and
wherein the edge region of the transparent substrate corresponds to a peripheral vision region of the user.

5. The glass module for the AR glasses of claim 1, wherein the in-coupler and the light transmitter are attached to the edge region of the transparent substrate.

6. The glass module for the AR glasses of claim 5, wherein the in-coupler comprises: an upper in-coupler configured to receive a part of the virtual image and to split the part of the virtual image upwardly; and a lower in-coupler configured to receive a part of the virtual image and to split the part of the virtual image downwardly,
wherein the light transmitter comprises: an upper light transmitter configured to transmit the virtual image which is split upwardly by the in-coupler to an upper out-coupler; and a lower light transmitter configured to transmit the virtual image which is split downwardly by the lower in-coupler to a lower out-coupler,
wherein the out-coupler comprises the upper out-coupler configured to emit the virtual image transmitted through the upper light transmitter; and the lower out-coupler configured to emit the virtual image transmitted through the lower light transmitter.

7. The glass module for the AR glasses of claim 6, wherein the upper out-coupler is attached to an upper region of the transparent substrate, and the lower out-coupler is attached to a lower region of the transparent substrate.

8. The glass module for the AR glasses of claim 7, wherein the upper in-coupler, the lower in-coupler, the upper light transmitter, and the lower light transmitter are attached to outer side regions of the transparent substrate.

9. The glass module for the AR glasses of claim 7, wherein the upper out-coupler and the lower out-coupler are configured to emit the virtual image to a plurality of out-coupler elements at a plurality of points.

10. An AR virtual image display method comprising:
receiving, by an in-coupler attached to a transparent substrate, a virtual image;
transmitting, by a light transmitter attached to the transparent substrate, the virtual image entering through the in-coupler to an out-coupler; and
emitting, by an out-coupler attached to the transparent substrate, the virtual image transmitted through the light transmitter to user's pupil,
wherein the out-coupler is attached to an edge region of the transparent substrate.

11. AR glasses comprising:
a left-eye glass module configured to display a left-eye virtual image on user's left eye;
a right-eye glass module configured to display a right-eye virtual image on user's right eye;
a left-eye projection module configured to project the left-eye virtual image to be displayed through the left-eye glass module; and
a right-eye projection module configured to project the right-eye virtual image to be displayed through the right-eye glass module,
wherein each of the left-eye glass module and the right-eye glass module comprises:
a transparent substrate;
an in-coupler attached to the transparent substrate to allow a virtual image to enter therethrough;
a light transmitter attached to the transparent substrate to transmit the virtual image entering through the in-coupler to an out-coupler; and
an out-coupler attached to the transparent substrate to emit the virtual image transmitted through the light transmitter to user's pupil,
wherein the out-coupler is attached to an edge region of the transparent substrate.
